(19) United States
(12) Patent Application Publication
(10) Pub. No.: US 2018/0260837 A1
(43) Pub. Date: Sep. 13, 2018

(54) METHOD FOR AWARDING A BONUS TO A PERSON IN A SALES POINT AND COMMUNICATION SYSTEM AND UNIQUE MESSAGE USED THEREIN

(71) Applicant: HASHTING BVBA, Lint (BE)

(72) Inventor: Karl Denijs Gustaaf DE BEUL, Lint (BE)

(21) Appl. No.: 15/559,134

(22) PCT Filed: Mar. 17, 2016
(86) PCT No.: PCT/IB2016/051507

§ 371 Date: Sep. 18, 2017

(30) Foreign Application Priority Data
Mar. 20, 2015 (BE) 2015/5164

(51) Int. Cl. G06Q 30/02; H04W 4/14

(52) U.S. Cl. CPC G06Q 30/0238; H04W 4/14; G06Q 30/0236

(57) ABSTRACT

A method for awarding a bonus to a person in a sales point or the like by means of a unique message which is present in the sales point and is linked individually thereto and which allows said person to send a notification which is linked to the unique message via a communication terminal to a central platform where the received notification allows the sales point which is linked to the unique message to be identified and the communication terminal from which the notification was sent to be identified and, following registration of the bonus on the identified sales point and the identified communication terminal, to send a response for the awarding or non-awarding of the bonus, said response allowing the person to claim the bonus by showing the response to the sales assistant.

### TECHNICAL FIELD

The present invention relates to a method for awarding a bonus to a person in a sales point.

A bonus is understood here to mean a discount for a product, item or service, but also a product, item or service that can be obtained free of charge, possibly if specific conditions are satisfied.

### BACKGROUND TO THE INVENTION

Bonuses are traditionally awarded in different ways to persons or consumers.

A first way involves the use of (paper) discount vouchers.

These discount vouchers are distributed, for example, by the manufacturers via promotional leaflets, daily and weekly newspapers and the like.

One disadvantage hereof is that the consumer must cut or tear these out and keep them until he goes to a sales point where he can use the discount voucher. This often represents a substantial obstacle for consumers in order to use the discount voucher.

A considerable time often elapses between the cutting out and actual use of the discount voucher, as a result of which it is possible that the consumer ultimately loses or does not use the discount voucher.

Furthermore, the consumers in the sales point often do not know that a bonus can be obtained, simply because the consumers do not have a discount voucher.

Many discount vouchers will also be issued to consumers who are not interested in the bonus.

This results in a substantial loss of potential consumers, whereby a relatively large number of discount vouchers must be provided for often only a handful of actual using consumers.

Furthermore, these discount vouchers often entail a large and often pointless consumption of raw materials such as paper and ink.

A different approach is to publicise the bonus by means of a promotional label, for example by attaching a sticker or the like to the packaging of the products to which the bonus applies.

The advantage of this is that the consumer in situ, in the sales point itself, can be made aware and can decide whether or not to obtain the bonus.

One disadvantage of this is that all products to which the bonus applies must be separately provided with a promotional label, wherein the stock of products with a promotional label will have to be replenished in a timely manner. This requires close monitoring and is obviously very time-consuming.

A further disadvantage is that a high consumption of raw materials such as paper and ink is involved in this case also.

A further different way to offer a bonus is by attaching the bonus, such as, for example, a price reduction, to the price label in the sales point.

This offers the advantage that the product itself to which the bonus applies no longer has to be provided with a promotional label.

The price label will nevertheless still have to be replaced.

However, one disadvantage is that the bonus is much less conspicuous for the consumer and sometimes remains unnoticed because the price label has only restricted dimensions.

Furthermore, it is possible that the dealer of the sales point commits fraud by offering a small price reduction, thereby increasing his own profits.

A further disadvantage is that the bonus cannot be applied or stopped immediately, if the manufacturer so wishes, given that he must ask the dealer to apply the bonus in the shop.

One disadvantage of all the methods described above for offering a bonus is that the manufacturer of the products to which the bonus applies does not immediately have an overview of the products already sold, but is dependent in this respect on the dealers of the different sales points who must supply these data to the manufacturers.

Furthermore, the dealer will also have to wait a relatively long time for the reimbursement of the discount vouchers and the like.

### SUMMARY OF THE INVENTION

The object of the present invention is to offer a solution to at least one of said and other disadvantages.

The subject-matter of the present invention is a method for awarding a bonus to a person in a sales point or the like by means of a unique message which is present in the sales point and is linked individually thereto and which allows said person to send a notification which is linked to the unique message via a communication terminal to a central platform where the received notification allows the sales point which is linked to the unique message to be identified and the communication terminal from which the notification was sent to be identified and, following registration of the bonus on the identified sales point and the identified communication terminal, to send a response for the awarding or non-awarding of the bonus, said response allowing the person to claim the bonus by showing the response to the sales assistant.

A bonus is understood here to mean, for example, a discount which the person can obtain if he purchases a product, item or service to which the bonus relates. However, a bonus may also be, for example, a free product or item.

A communication means is understood here to mean, for example, a mobile telephone, smartphone, tablet, portable computer or the like. This includes any communication terminal which enables the person to set up a connection to a telephone network or the Internet. The communication terminal is preferably portable and/or wireless.

A sales point refers very generally to a location where a bonus is offered and/or awarded. These are, inter alia, shops, commercial outlets, cafes, restaurants, bars and the like but also, for example, event locations such as festivals or football matches, fast food outlets, businesses, temporary commercial outlets, etc.

One advantage of a method according to the invention is that the person in the sales point is himself made aware of the bonus, whereby this person can himself decide at that moment whether or not to use the bonus. The person does not have to overcome any substantial obstacle or make much effort in order to use the bonus, such as, for example, cutting out and retaining discount vouchers.

Furthermore, all potential consumers are reached, which is not always the case with discount vouchers.

Another advantage is that no discount vouchers or the like have to be provided in order to be able to claim the bonus. Associated unused or lost discount vouchers are therefore also avoided.

Another further advantage is that no time is wasted in providing the individual products to which the bonus applies with a promotional label or the like. For example, one central display, poster or the like is sufficient.

An additional advantage is that a display of this type can be designed as conspicuous and readily visible.

The central platform will be able to identify the location, i.e. the sales point on the basis of the notification and will also be able to identify the communication terminal. This identification may consist, for example, in registering the telephone number if it involves a mobile telephone or smartphone.

This offers the advantage that the number of bonuses which the person can claim can be restricted. Fraud is avoided in this way. Even if a person tries to claim the same bonus in different sales points, this can be detected by the central platform.

Another advantage of this is that the central platform will be able to register how many and in which sales point bonuses are claimed. This will provide the manufacturer of the product or item to which the bonus is applicable with an overview of the claimed bonuses. This overview can be updated or presented in real time. This will allow the manufacturer to apply the bonus very quickly if required.

It will hereby also be possible for the dealer offering the bonus in his sales point to be reimbursed quickly for the bonuses that have been claimed in his sales point.

A further additional advantage is that fraud by the dealer is excluded, given that the response is sent via the central platform. This can also be ensured, for example, by explicitly specifying the bonus, such as, for example, the amount of the discount, once more in the response.

An additional advantage is also that a method of this type can also be applied in situations or sales points where the traditional forms of discount vouchers or price reduction on the price label are not traditionally customary. Examples include fast food outlets or cafes, bars, restaurants and the like.

Furthermore, the bonuses are now directly linked to the number of sold products in sales points (selling-out) and not to the number of products bought in by the sales points or distributors (selling-in).

The invention also relates to a communication system for awarding a bonus to a person in a sales point or the like, wherein the communication system comprises a central platform and a unique message for the bonus which is present in the sales point and is linked individually thereto, wherein the unique message allows said person to send a notification via a communication terminal which is linked to the unique message to the central platform, wherein the central platform can identify the sales points which is linked to the unique message on the basis of the received notification and can identify the communication terminal from which the notification was sent and, following registration of the bonus at the identified sales point and the identified communication terminal, sends a response for the awarding or non-awarding of the bonus, said response allowing the person to claim the bonus by showing the response to the sales assistant.

The invention also relates to a unique message for awarding a bonus to a person in a sales point or the like by means of the unique message which is present in the sales point and is linked individually thereto and which allows said person to send a notification which is linked to the unique message via a communication terminal to a central platform where the received notification allows the sales point which is linked to the unique message to be identified and the communication terminal from which the notification was sent to be identified and, following registration of the bonus on the identified sales point and the identified communication terminal, to send a response for the awarding or non-awarding of the bonus, said response allowing the person to claim the bonus by showing the response to the sales assistant.

The invention also relates to a central platform comprising a database with unique messages linked individually to respective bonuses and sales points; and wherein the central platform is configured to carry out the following steps:
receiving a notification from a communication terminal of a person who is present in a sales point;
extracting a unique message from the notification, and wherein the unique message is present in the sales point;
identifying the sales point and a bonus based on the database and the unique message;
registering the bonus in the database;
generating a response which allows the bonus to be claimed at the sales point by showing the response to a sales assistant in the sales point;
sending the response to the communication terminal of the person.

The central platform can furthermore be configured to determine whether the bonus will or will not be awarded on the basis of a specific criterion.

The receiving of a notification may furthermore comprise the receiving of a notification via social media or via an SMS message.

The unique message may furthermore comprise a QR code, barcode or the like which forms the notification which the person can scan with his communication terminal, whereby the communication terminal automatically makes contact with the central platform.

The unique message may furthermore comprise instructions for being able to compose the notification.

The central platform may furthermore be configured to check, manage and/or retain the identity of the person.

The central platform may furthermore be configured to pay out registered bonuses at the sales points.

The response may furthermore comprise an announcement which is presented on the screen of the communication terminal.

The bonus may furthermore comprise the acquisition of an additional product, and the central platform is then furthermore configured to maintain a stock indication of the additional product at the sales point.

The central platform may furthermore be configured to modify the bonus on the basis of environmental factors or events.

The central platform may furthermore be configured to make the unique message available at the sales point.

The central platform may furthermore be configured to send the unique message to the sales point and immediately present it on a display in the sales point.

Said central platform, communication system and said unique message are used in a method according to the invention and the advantages thereof are similar to said advantages of the method.

With a view to providing a clearer explanation of the invention, a number of preferred applications are described below, by way of example without any limiting character, of the method according to the invention for awarding a bonus and a communication system and unique message used therein, with reference to the attached drawings.

### BRIEF DESCRIPTION OF THE FIGURE

FIG. 1 shows schematically a method and central platform according to one embodiment of the invention.

### DETAILED DESCRIPTION OF THE EMBODIMENTS

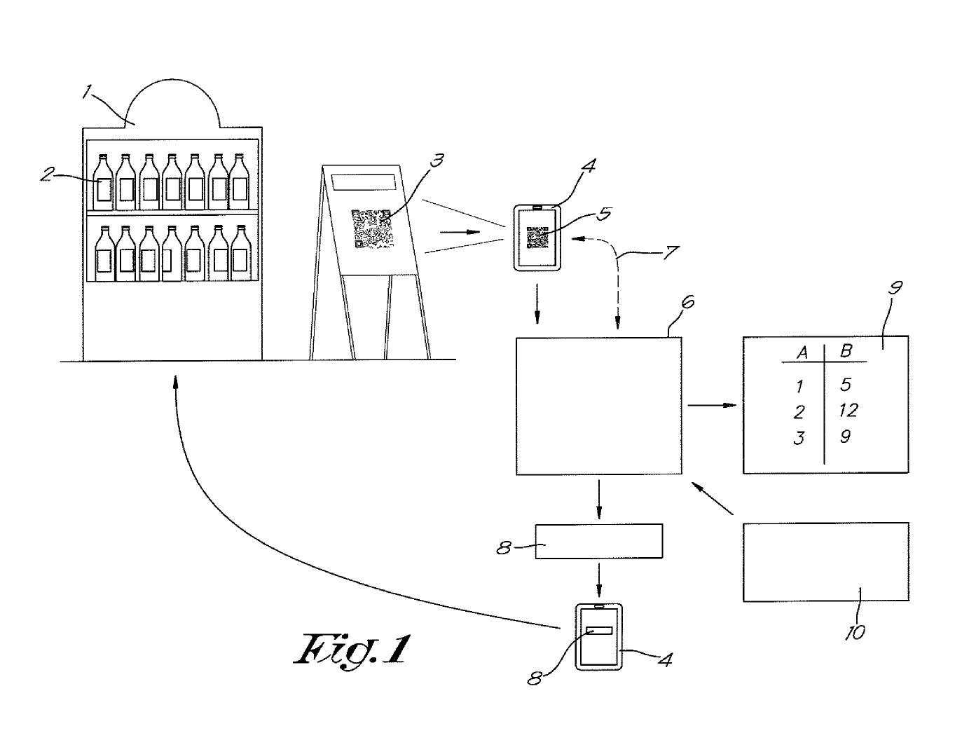

The method shown schematically in FIG. 1 starts in this case from a sales point 1 where a bonus is offered, for example in the form of a discount when purchasing a product 2.

It is clear that the bonus may assume many different forms. Without limiting the invention thereto, the bonus may also relate to a free product 2 which can be obtained or a discount on a service which is offered in the sales point 1.

In order to make a person in the sales point aware of the bonus, a unique message 3 is present in the sales point 1.

The term ‘unique’ is understood here to mean that the unique message 3 is linked individually, i.e. on a one-to-one basis, to the bonus and to the sales point 1. In other words, the bonus and the sales point 1 can be identified unambiguously from the unique message 3.

The unique message 3 may assume different forms. A number of possibilities are, for example:
a QR code;
a barcode;
an image;
a text, with or without instructions.

A combination of the preceding examples will also be possible.

It is clear that the unique message 3 does not need to be restricted to visual messages, but, for example, may also comprise sound, such as, for example, a voice issuing an instruction.

The person who sees the unique message 3 in the sales point 1 and wishes to use the bonus will send a notification 5 which is linked to the unique message 3 via a communication terminal 4 to a central platform 6.

This may be implemented in different ways.

If the unique message 3 relates to a QR code as in FIG. 1, the person will be able to scan this QR code with a smartphone or tablet, after which the smartphone or tablet will guide the person to a website, in this case the central platform 6. In this case, the QR code therefore also serves as the notification 5.

The unique message 3 may, for example, also be an image which the person must photograph with his communication terminal 4 and must send to a specific website. In this case, the unique message 3 will comprise, as well as a photo, also a text with an instruction to photograph the photo and send it to the website.

If the unique message 3 is simply a text, this text may, for example, comprise an instruction which allows the person to compose a notification 5 and forward it, for example via an SMS message, to the central platform 6. In this case, the central platform 6 will be a central facility where these SMS messages can be processed.

The advantage of using an SMS message is that it is commonplace. More or less everyone owns a mobile telephone with which an SMS message can be sent.

The notification 5 may, for example, be a special code on the basis of which the central platform 6 can identify the bonus and the sales point 1.

It is obvious that these instructions are preferably chosen as relatively simple, wherein the instructions are preferably limited to the issuing of the notification 5 and, for example, the number to which the notification 5 must be sent.

Instead of the notification 5 having to be sent via an SMS message, it is also possible that the notification has to be sent via social media, such as, for example, Twitter, Facebook, Instagram, LinkedIn.

In an optional step, represented by the dotted-line arrow 7, the person will have to identify himself via social media or via the communication terminal 4, wherein the central platform 6 checks, manages and/or retains the identity of the person.

This may be implemented, for example, by guiding the person, after he has scanned the QR code, to a web page where he must log in.

However, this identification may equally be carried out in that, if the person sends an SMS notification to the central platform 6, the central platform 6 registers the telephone number.

If the central platform 6 receives the notification 5 from a person, the central platform 6 will be able to identify the sales point 1 herewith.

The central platform 6 can award or not award a bonus on the basis of the identified communication terminal 4 and the identified sales point 1.

The bonus is preferably awarded on the basis of a specific criterion. This criterion may, for example, be that only one bonus is awarded per communication terminal 4 or per person, or that only a limited number of bonuses are awarded per sales point 1, so that, if all bonuses have been claimed, no further bonuses are awarded.

The central platform 6 will send a response 8 to the communication terminal 4 for the awarding or non-awarding of the bonus.

This response 8 may comprise, for example, an announcement which is displayed on the screen of the communication terminal 4. This announcement may, for example, be an SMS message confirming whether the bonus has been awarded to the person.

By means of the response 8, the person can claim the bonus by sending the response to the sales assistant in the sales point 1.

It is clear that the entire process from the time when the person becomes aware of the bonus in the sales point 1 to the claiming of the bonus requires only a few minutes.

It is clear that, in order to carry out a method according to the invention, the communication system which comprises the central platform 6 and the unique message 3 will allow everything to be managed centrally, for example by the manufacturer offering the bonus. This offers a number of significant advantages.

With the communication system, not only can the persons make contact via the communication means 4 in order to send the notification 5 and receive the response 8, but also the manufacturers can decide whether or not to adjust the bonus.

The central platform 6 preferably comprises a database 9 of the bonuses, sales points 1 and the awarded bonuses on the basis of which the central platform 6 controls the payment of the sales point 1 and the possible adjustment of the bonuses.

The manufacturer 10 can thus check at any time how many bonuses have already been awarded.

Furthermore, the manufacturer 10 can modify the bonus easily and immediately via the central platform 6.

Since the manufacturer 10 has an overview of the awarded bonuses in the different sales points 1 at all times, the manufacturer 10 will also be able to reimburse the sales points more quickly.

In some cases, the bonus may relate to the acquisition of an additional product with the purchase of one or more other products. In such a case, the sales point will have to maintain a stock of these additional products. The central platform 6 can then maintain the stock of these products in each sales point 1 in real time and present a stock indication to the manufacturer. In this way, the manufacturer can, on the one hand, limit the stock in the sales points and, on the other hand, have the stock replenished directly if necessary.

It is also possible to make the bonus dependent on external parameters such as environmental factors or an event. In this way, the bonus can be awarded in a dynamic manner. The bonus can thus be modified by the central platform at fixed times. The size of a discount may, for example, be made progressive or regressive with time. The awarding or non-awarding of the bonus or the size of the bonus may, for example, also be made dependent on the temperature. On receiving the unique message, the central platform can then consult the temperature and make the bonus dependent on it. In addition to environmental factors, the bonus may also be made dependent on a one-off event such as, for example, a sporting event.

If social media are used, the central platform 6 may also comprise a website or an online database. This means that almost the entire process runs via the Internet.

This allows the manufacturer or the sales point 1 to be given access to the central platform 6 in order to thus benefit from additional services. A manufacturer or sales point 1 can thus itself directly create the unique messages and therefore the bonuses on the central platform 6. This can also allow the sales point 1 itself to obtain the unique message 3 via the central platform 6, for example by downloading or printing off the message. In this way, a promotion can be implemented in the sales point without the intervention of a third party.

If the unique message is visual or graphical, it can be printed off on a medium or can be presented digitally on a display in the sales point 1. This display can then furthermore be connected to the central platform. In this way, the central platform can also adapt the unique message itself in real time, for example on the basis of external parameters such as environmental factors or an event of the type already described above.

Although the example shown in FIG. 1 relates to only one sales point 1 and one bonus, it is clear that there may also be more than one sales point 1 and/or more than one type of bonus. This will usually be the case in practice.

In this case, there will also be a plurality of unique messages 3 and a different unique message 3 will preferably be used for each type of bonus in each sales point 1. The central platform 6 will then be provided with a database or the like where the different sales points 1 and/or bonuses are stored, each unique message being linked to a specific bonus in a specific sales point 1. In other words, an individual relationship between the different unique messages 3 and the different types of bonuses and/or sales points 1 is stored in the central platform 6.

In this case, the communication system comprises one central platform 6 and a number of unique messages 3.

On the basis of the received notifications 5, the central platform 6 will be able to register and keep track of which bonuses have been claimed in which sales points 1 and will be able to report this, in a manner of speaking, in real time to the manufacturer 10.

In this way, the manufacturer 10 has an overview of how many bonuses have already been claimed in which sales points 1.

The present invention is in no way limited to the embodiments described as examples and shown in the figures, but rather the method according to the invention for awarding a bonus and a communication system and unique message used therein can be implemented according to different variants without exceeding the scope of the invention.

1.-31. (canceled)

32. A central platform comprising a database with unique messages linked individually to respective bonuses and sales points; and
wherein the central platform is configured to carry out the following steps:
receiving a notification from a communication terminal of a person who is present in a sales point;
extracting a unique message from the notification, and wherein the unique message is present in the sales point;
identifying the sales point and a bonus based on the database and the unique message;
registering the bonus in the database;
generating a response which allows the bonus to be claimed at the sales point by showing the response to a sales assistant in the sales point;
sending the response to the communication terminal of the person.

33. The central platform according to claim 32, wherein the central platform is configured to determine whether the bonus will or will not be awarded on the basis of a specific criterion.

34. The central platform according to claim 32, wherein the receiving of a notification comprises the receiving of a notification via social media or via an SMS message.

35. The central platform according to claim 32, wherein the unique message comprises a QR code, barcode or the like, which forms the notification which the person can scan with his communication terminal, wherein the communication terminal automatically makes contact with the central platform.

36. The central platform according to claim 32, wherein the unique message comprises instructions for being able to compose the notification.

37. The central platform according to claim 32, wherein the central platform is configured to check, manage and/or retain the identity of the person.

38. The central platform according to claim 32, wherein the central platform is configured to pay out registered bonuses at the sales points.

39. The central platform according to claim 32, wherein the response comprises an announcement, which is presented on the screen of the communication terminal.

40. The central platform according to claim 32, wherein the bonus comprises the acquisition of an additional product, and the central platform is configured to maintain a stock indication of the additional product at the sales point.

41. The central platform according to claim 32, wherein the central platform is configured to modify the bonus on the basis of environmental factors or events.

42. The central platform according to claim 32, wherein the central platform is configured to make the unique message available at the sales point.

43. The central platform according to claim 32, wherein the central platform is configured to send the unique message to the sales point and present it directly on a display in the sales point.

44. A method for awarding a bonus to a person in a sales point or the like by means of a unique message which is present in the sales point and is linked individually thereto and which allows said person to send a notification which is linked to the unique message via a communication terminal to a central platform where the received notification allows the sales point which is linked to the unique message to be identified and the communication terminal from which the notification was sent to be identified and, following registration of the bonus on the identified sales point and the identified communication terminal, to send a response for the awarding or non-awarding of the bonus, said response allowing the person to claim the bonus by showing the response to the sales assistant.

45. The method according to claim 44, wherein the bonus is awarded on the basis of a specific criterion.

46. The method according to claim 44, wherein the consumer sends the notification to the central platform via social media or via an SMS message.

47. The method according to claim 44, wherein the unique message comprises a QR code, barcode or the like, which forms the notification which the person can scan with his communication terminal, wherein the communication terminal automatically makes contact with the central platform.

48. The method according to claim 44, wherein the unique message comprises instructions for being able to compose the notification.

49. The method according to claim 44, wherein the person must identify himself via social media or via the communication terminal, wherein the central platform checks, manages and/or retains the identity of the person.

50. A communication system for awarding a bonus to a person in a sales point or the like, wherein the communication system comprises a central platform and a unique message for the bonus which is present in the sales point and is linked individually thereto, wherein the unique message allows said person to send a notification via a communication terminal which is linked to the unique message to the central platform, wherein the central platform can identify the sales points which is linked to the unique message on the basis of the received notification and can identify the communication terminal from which the notification was sent and, following registration of the bonus at the identified sales point and the identified communication terminal, sends a response for the awarding or non-awarding of the bonus, said response allowing the person to claim the bonus by showing the response to the sales assistant.

51. A communication system according to claim 50, wherein the communication system comprises more than one unique message, for different types of bonuses and different sales points, wherein an individual relationship between the different unique messages and the different types of bonuses and/or sales point is stored in the central platform.
